(19) United States
(12) Patent Application Publication
(10) Pub. No.: US 2005/0088313 A1
(43) Pub. Date: Apr. 28, 2005

(54) Programmable external event triggering apparatus and method

(75) Inventors: Ray LeBlanc, Bristol, CT (US); Angelo Arcaria, Colchester, CT (US); Kenneth R. Taylor, Ivoryton, CT (US)

Correspondence Address: Baker & Hostetler LLP;Washington Square, Suite 1100, 1050 Connecticut Avenue, N.W., Washington, DC, 20036, US

(73) Assignee: Edwards Systems Technology, Inc.

(21) Appl. No.: 10/972,323

(22) Filed: Oct. 26, 2004

Related U.S. Application Data
(63) Continuation-in-part of application No. 10/664,911, filed on Sep. 22, 2003.

(51) Int. Cl. G08B 1/00

(52) U.S. Cl. 340/825.24

(57) ABSTRACT

A programmable event driver/interface can respond to external inputs. A combined hardware/software interface allows for direct communication with individual annunciators and dynamic grouping of annunciators by zone. Events originating outside the system can be looked for at a selectable rate, announced, and monitored as separate annunciator operations.

### CROSS-REFERENCE TO RELATED APPLICATIONS

This application claims priority to and is a continuation-in-part of U.S. patent application entitled, “PROGRAMMABLE EVENT DRIVER/INTERFACE APPARATUS AND METHOD,” filed Sep. 22, 2003, having a Ser. No. 10/664,911, now pending, the disclosure of which is hereby incorporated by reference in its entirety.

### FIELD OF THE INVENTION

The present invention relates generally to signaling and annunciator systems. More particularly, the invention relates to software-driven command and control of remote signaling, sensing, and actuation apparatus.

### BACKGROUND OF THE INVENTION

Annunciator and paging systems within such facilities as factories, office buildings, parks, schools, and the like can use electrically activated bells as well as speaker-generated tones to announce normal periodic events such as breaks, shift changes, and other non-emergency events. Such systems are commonly limited to a single sound, in the case of those using horns or mechanical bells, and a range of sounds, in the case of those using speakers and driven from a central audio tone source.

Some annunciator system designs use loudspeakers at a number of locations. In some versions, the loudspeakers are wired in parallel, with each speaker transformer-isolated, which can permit high transmitter signal voltage at low current, reducing copper losses, and which can further prevent some types of single-point failures from disabling an entire system. Other designs, which send signals from a central source at comparatively low power levels, incorporate annunciators equipped with amplifiers and may have power supplies driven by, for example, facility AC power.

Whether remotely or locally powered, systems that feature multiple zones to be signaled at different times or under different circumstances may be directly wired by zone from a shared control panel. Annunciators wired individually back to a control panel may be activated individually using switches. Volume control may be realized using a central attenuator or an attenuator at each speaker.

Digital annunciator designs can include direct addressing of individual annunciators through a signal distribution system, so that a digital communication processor circuit in an individual annunciator can recognize its own address and respond appropriately.

It would be desirable for annunciator systems to benefit from computer technology to a greater extent than has been done heretofore, specifically by providing capabilities beyond the above-described annunciation functions. Such capabilities include at least interaction with remotely located processor-based machines, transmitting control signals to and receiving reports from autonomous sensing devices, accessing extended communications systems, and other capabilities beyond the previous limits of annunciation technology.

### SUMMARY OF THE INVENTION

The foregoing needs are met, to a great extent, by the present invention, wherein in one aspect an apparatus is provided that in some embodiments provides resources that allow a process monitor external to an annunciator system to send a transmission to a central controller that is a part of the annunciator system. The central controller can respond to such transmissions by broadcast of a user-created audible signal, output of other types of announcements, or actuation of other resources. Response to inputs from outside the annunciator system can be supported in addition to normal activities such as monitoring and logging of annunciator system state of health, emitting signals at periodic intervals, and supporting a user interface.

In accordance with one embodiment of the present invention, a programmable annunciator system is presented. The programmable annunciator system includes a master controller and a satellite controller distal to the master controller. The satellite controller is linked to a device external to the programmable annunciator system. The satellite controller includes an interface device configured to receive an information element concerning the external device. The programmable annunciator system further includes a communications medium that links the master controller and the satellite controller, and a message protocol configured to support signal interchange between the master controller and the satellite controller.

In accordance with another embodiment of the present invention, a programmable annunciator system is presented. The programmable annunciator system includes means for generating a polling message in a master controller, wherein the polling message includes an address for a satellite controller, means for transmitting the polling message from the master controller, and means for conveying the polling message from the master controller to at least one satellite controller, wherein the at least one satellite controller is configured to acquire an information element from an external source.

In accordance with yet another embodiment of the present invention, a method for annunciating in a system that accepts external inputs is presented, including the steps of transmitting a polling message from a master controller, wherein the polling message comprises an address for a satellite controller, and wherein the polling message further comprises a request for a reply from the satellite controller, receiving the polling message at the satellite controller, analyzing the polling message at the satellite controller, and generating a reply at the satellite controller. The reply includes a plurality of information elements, which information elements include an address echo for the satellite controller, a signal indicating whether the satellite controller is external-input capable, and a status signal for the satellite controller. The steps in the annunciation further include transmitting the reply by the satellite controller to the master controller.

There have thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrange ments of the components set forth in the following description or illustrated in the drawings. The invention is capable of embodiments in addition to those described, and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an overall block diagram of an annunciator system with a central control processor and multiple remote annunciators.

FIG. 2 is a software block diagram identifying functions that provide annunciator functionality in a central control processor-based annunciator system.

FIG. 3 is a software flowchart identifying an initialization sequence for a central control processor operating multiple remote annunciators.

FIG. 4 is a software flowchart identifying steps in polling a single annunciator.

FIG. 5 is a software flowchart summarizing steps in sending a single tone of fixed duration to one annunciator.

FIG. 6 is a software flowchart identifying steps in integrating time computations in an annunciator system.

FIG. 7 is a screen shot showing a nominal system with multiple annunciators configured in a variety of modes.

FIG. 8 is a block diagram of an annunciator system supporting external input functions.

FIG. 9 is a schematic diagram of an interface between an annunciator system and representative external devices.

FIG. 10 is a software flowchart identifying steps in operating an annunciator system in which external inputs are detected.

### DETAILED DESCRIPTION OF THE PREFERRED EMBODIMENT

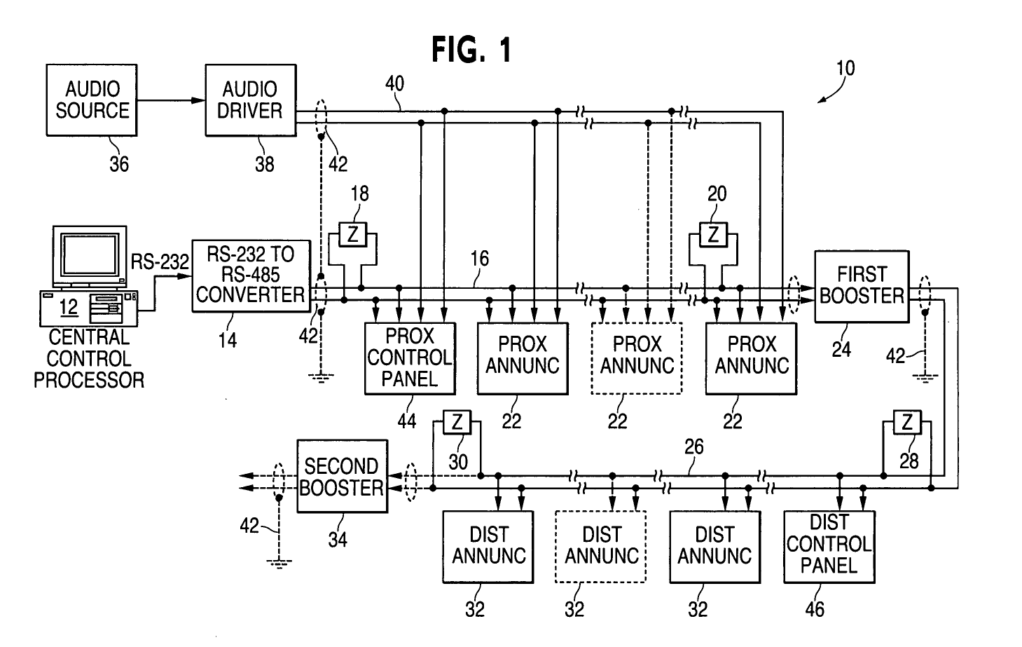

An embodiment of the present inventive apparatus and method is illustrated in FIG. 1. FIG. 1 shows an annunciator system 10 in which a central control processor 12 generates signals that are transformed by a transceiver, such as an IEC-232 to IEC-485 converter 14, that enables the signals to be carried outward on a differential, controlled-impedance transmission line 16 featuring a beginning-of-line termination load 18 and an end-of line termination load 20, until the signals are detected by the receiver section of at least one proximal annunciator 22. Since the transmission system is bidirectional, response signals transmitted by the proximal annunciator 22 can propagate back on the transmission line 16 to the transceiver 14, which transforms the response signals into condition to be detected by the central control processor 12. The termination loads 18 and 20 attenuate reverberation, thus allowing bidirectional communication along a longer transmission line 16, even with the weaker signals likely to be present further from the signal source.

IEC-485 is a so-called Recommended Standard (RS) developed by industry and adopted by the International Electrotechnical Commission (IEC). IEC-485 is a bused system that uses a serial data stream for communication between one talker at a time and multiple listeners. IEC-485 is distinguished from IEC-232 (also known as RS-232) in having differential (preferably balanced) rather than single-ended signal capability, in supporting up to a 1.2 KM wire length rather than a nominal 3 meter limit, in supporting multiple peripheral or satellite loads wired in parallel rather than one master device and one peripheral, and in having some tolerance of variations in ground voltage levels. IEC-485 is often configured to permit multiple talkers to talk in turn. IEC-485 supports both half-duplex (2-wire plus ground reference; interrogate and reply messages alternate) and full-duplex (4-wire plus ground reference; replies on second bus) communication, and can be made synchronous with a clock on a third pair. The message bits in an IEC-485 transmission may serve as alert signals, address bits, data bits, and checksums, and may also be assigned other functions.

FIG. 1 further shows a first booster 24, driving an extended transmission line 26, which can be equipped with extended-line termination loads 28 and 30 to permit communication with at least one distal annunciator 32, further extending the transmission range from the central control processor 12. The range can be extended further still with a second booster 34, driving additional annunciators, not shown.

FIG. 1 further shows an audio source 36 and an audio driver 38, whose outputs, carried on an analog transmission line 40, are received by analog sections of any annunciators 22 and/or 32 for which such functions may be required and installed. Even at a low baud rate, the digital transmission line 16 may carry signal components with comparatively high bandwidth. In systems in which the analog transmission line 40 carries lower bandwidth signals, the controlled impedance desirable to aid the performance of a digital transmission line 16 may be less critical for the analog line 40. Shielding 42 that can further enhance digital performance and range may provide significant benefit to the analog line 40, however, especially in an electrically noisy environment, where the shielding 42 may reduce induced noise in the analog circuitry of individual annunciators 22 and/or 32.

The converter 14 shown in FIG. 1 is a differential transceiver, which characteristic increases the noise immunity of the network including the converter 14, the transmission line 16, proximal annunciators 22, any boosters 24, any distal annunciators 32, and termination loads 18, 20, 28, and 30. Shielding 42 may lower digital noise, further increasing effective range. A representative multi-drop—that is, having several annunciator loads—differential transceiver system according to the embodiment shown generally conforms to IEC-485. The second and third pairs supported in IEC-485 may be desirable in some embodiments. Alternative transceiver hardware embodiments that can have satisfactory performance under some design regimes may conform to Institute of Electrical and Electronics Engineers (IEEE) standard IEEE-1394, generally referred to as FireWire®, or to others, such as transformer-coupled differential systems and fiber optic-based systems.

The audio driver 38 may be incorporated into a package with the IEC-485 driver, the latter shown in the system as an IEC-232 to IEC-485 converter 14. Similarly, the audio source 36 can be incorporated into the central control processor 12, for example using a sound amplifying circuit board or circuit function in an off-the-shelf personal computer used as the central control processor. An external source, such as a microphone or radio receiver, or an internal source, such as Internet radio or prerecorded programming material stored in the central control processor, can be the program source for sound to be emitted by selected annunciators 22 and/or 32.

Analog audio driver output signal levels of 10, 25, and 70 volts are common in annunciator products. These and other levels can be used in the system by selecting components compatible with the levels chosen. A 1-volt signal output from the audio source 36 feeding the audio driver 38 is a typical example.

Annunciator products that can be used with the system commonly use loudspeakers to communicate messages, such as tones, prerecorded voice messages, or other forms of audible signals. Lights such as strobe lights, light emitting diodes, or incandescent lamps can augment the communication function of the loudspeakers. Short-range radio transmitters can similarly be used to send sounds, vibrations, or other signals to receivers worn on the persons of individuals who may be unable to detect other annunciator signals. Signals from annunciators can similarly be used to activate functional features that may be needed under special circumstances, such as the release of electromagnetically-held doors.

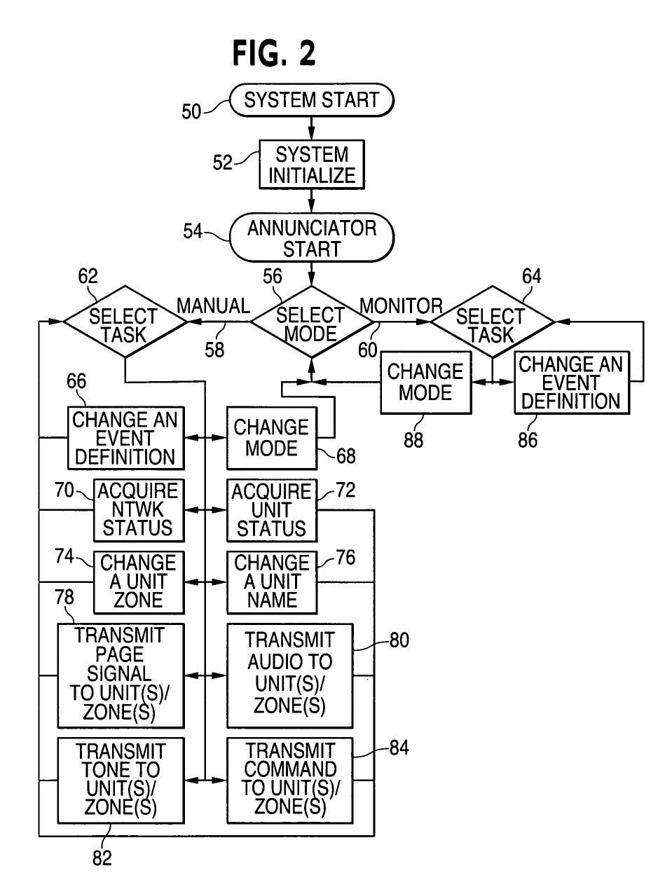

FIG. 2 shows functions of the central control processor. Since the processor in the system can be a general-purpose device, a Graphical User Interface supporting a general-purpose operating system, such as System X®, a Unix® flavor, or a Windows® flavor, can be employed to provide basic functionality and access to resources. Thus, after a system start event 50 such as power application, the initialization routine 52 can bring central control processor system memory, display, and interface resources on line before invoking 54 the annunciator control software to execute the annunciator central control. The core functional loop of the annunciator control software is the mode loop decision 56 to run in Manual 58 or Monitor 60 mode. Once this decision is made, the mode loop effectively repeats until changed by user intervention.

In Manual mode, a task select decision 62 can permit the user to choose between setup options, namely changing an event definition 66; acquiring network status 70; acquiring unit status 72; changing a unit's zone assignment 74; changing a unit's name as displayed 76; transmitting a paging signal to at least one unit or at least one zone 78; transmitting an audio signal to at least one unit or at least one zone 80; transmitting a tone signal to at least one unit or at least one zone 82; transmitting a command to at least one unit or at least one zone 84; or, following completion of a task, permitting changing mode 68.

Monitor mode in the embodiment shown consists principally of a loop in which polling of all annunciators identified as active at a regular rate, such as once every half-minute. In Monitor mode, a task select decision 64 can permit the user to change an event definition 86 or, following completion of that operation, to remain in that activity or change mode 88.

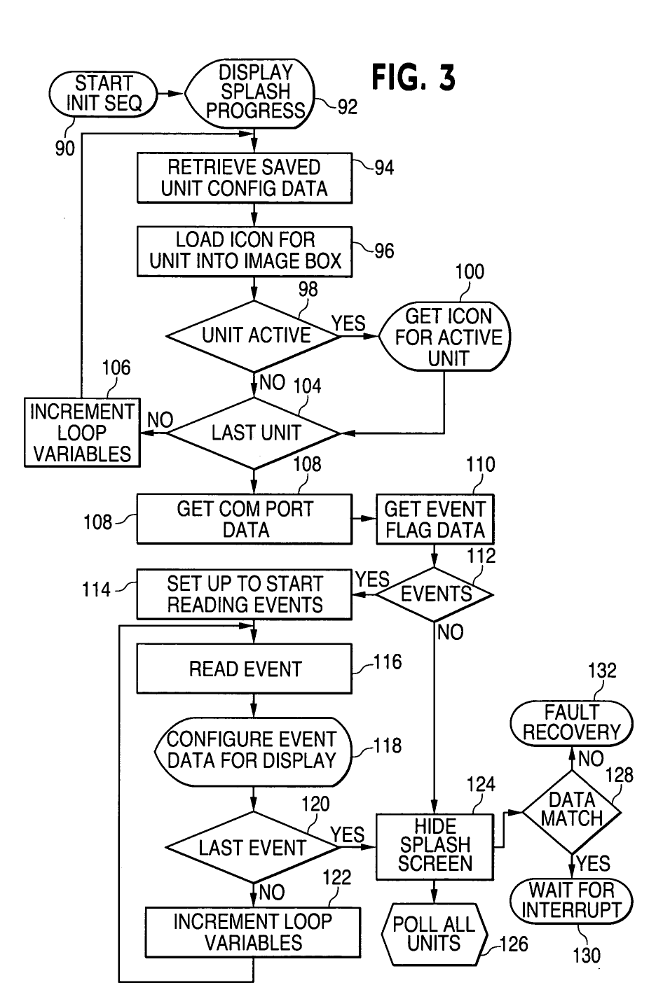

FIG. 3 details an initialization sequence for annunciator control software. From the invocation 90, there can be an initial display 92, commonly termed a splash screen, during software loading. The initial display 92 can further include a progress bar, that is, an uncalibrated display bargraph on which the bar advances to suggest the nearness to completion of initialization. Settings for variables used in initialization can be those established during software installation or can be default values. Those variables whose values have been most recently modified and saved, such as unit-by-unit address, zone, name, activity status, and type information, can be recalled from nonvolatile memory during the step of retrieving saved configuration 94. After this, the step of loading 96 the icon representing each unit into the Image Box can build an accurate display of the system hardware configuration.

As further shown in FIG. 3, for each unit addressed, if that unit is operational 98, the icon showing its type can be displayed 100 and the unit activation loop tested for completion 104. Until all addresses have been analyzed, the loop is incremented 106 and the initialization continues.

Continuing within FIG. 3, further system properties loaded 108 from an initialization file in nonvolatile memory can include communications port properties such as baud rate, handshaking conventions, parity, and stop bit rules as applied. Such data items relate to the use of a standard IEC-232 serial port or another equivalent port to establish communication between the central control processor and the IEC-485-linked annunciators.

Further initialization file data can include determination of existence 110 of event flags that require time dependent response. Where event flags exist 112, for each flag 114, data such as day code, day, date, unit, tone, start time, stop time, start string, stop string, and startup flag can be loaded 116, and displayed 118. Until 120 all flags have been loaded, the loop variables can be incremented 122 and the acquisition continued. Once all flags from the initialization file are loaded, initialization is substantially complete.

At this point during initialization, the splash screen can be disabled 124 and all units can be polled to confirm 126 that the current configuration agrees with that loaded from the data files. If all data agree 128, then the initialization sequence is complete and the system can wait for an interrupt 130 to pick up its next function. If there are errors, a fault recovery routine can be invoked 132.

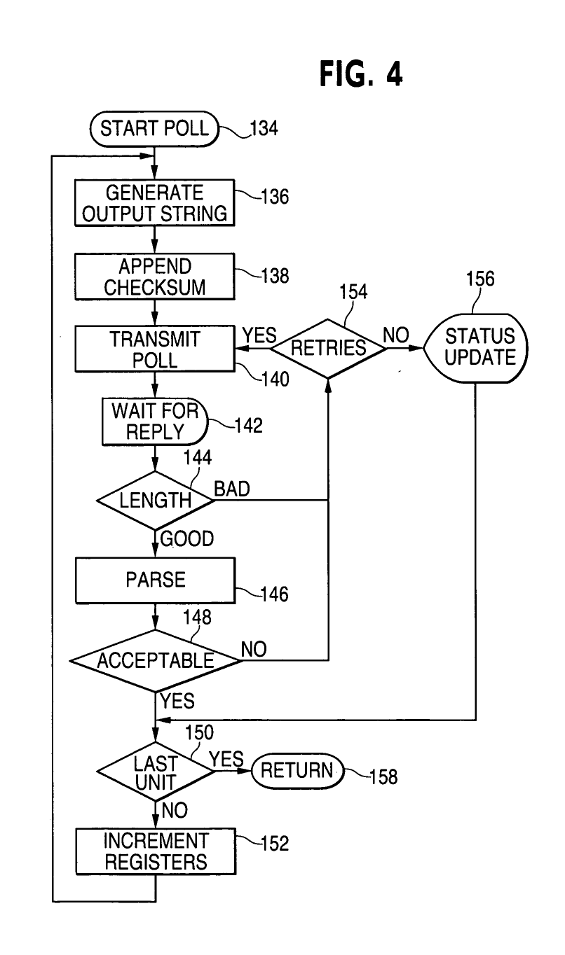

FIG. 4 displays the polling function referred to above. For a single annunciator, invoking polling 134 can generate an output 136 having an address and zone and a request for identity, followed by a checksum 138 to assure integrity. The signal so transmitted 140 can pass through central control processor hardware 12 to the converter 14 and transmission lines 16 to the polled annunciator 22. The addressed annunciator 22 may output a reply. The software can allow a hold 142 long enough to allow the signal to pass out through the parallel-to-serial function of IEC-232 and the converter, internal processing within the polled annunciator, and a transmission back through the signal path. If a reply arrives and has the correct characteristics 144, it can be parsed 146 and evaluated for content 148. If the content is valid, loop incrementing can proceed, with a test 150 for end of sequence, incrementing of variables 152, and repeating for the next annunciator. At the end of all polling, the function can return 158 to a calling routine.

If the content is invalid or the characteristics are in error, retransmission may be performed if the remaining number of allowable retries is greater than zero 154. If further retries are not allowed, the annunciator status can be marked bad or inactive 156 and polling can continue. A null response by the end of the hold time 142 is an example of a characteristic of error 144 that can advance the retry loop 154.

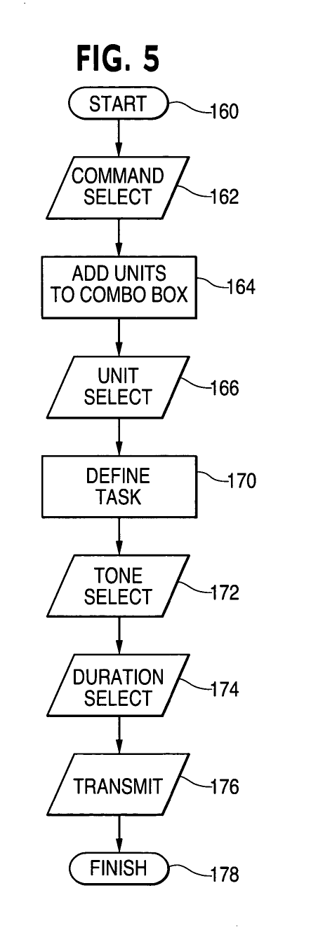

FIG. 5 shows a representative transmission to a single annunciator commanding a single tone of specified properties, including pitch and duration. When invoked 160, the program can prompt the user to enter the appropriate command type 162. Units capable of being activated for that command are identified and their identification entered into a list termed the combo box 164. The user may then specify a unit by filling in a field or picking from a list a unit to be accessed 166, depending on implementation preference. The software can define the operation further, identifying the zone to which the unit has been assigned and using that information to fill in the user interface data display, performing transmission setup operations, and the like.

The next indicated operation is selection 172 of the tone to be emitted. This can, for example, be chosen by the user from a dropdown list, typed in, or otherwise entered from the possible range for the unit in question. If the entry is open ended, as in a typed-in field, then it may be necessary to perform a verification test; if the entry is a dropdown list, then the verification step 166 may not be required for unit selection.

The last setup operation in the embodiment shown is selection of duration 174. As in the cases indicated above, this can be a selection from a dropdown or other list, or can be filled in and verified. As implemented, a duration setting of zero can be defined as a signal to turn on the tone generator and leave it on. For this embodiment, a separate command can be provided to turn the tone generator off. Alternative embodiments can implement an equivalent function by such methods as assigning a continuous tone command, which can for example include a datum indicating that the tone starts or ends as a response to reception of the continuous tone command.

Setup can be followed by activation. Where that applies, the transmit command 176 can be issued by a mouse click on a software button, by a keystroke, or by other means. Since this step ends the routine in this embodiment, the finish step 178 may typically be a return to a calling routine.

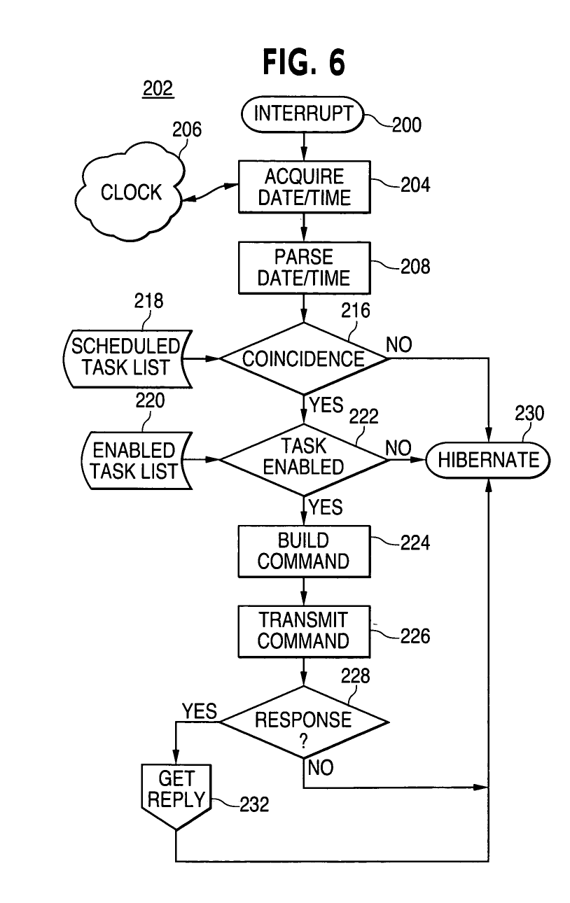

FIG. 6 shows in flowchart form a basic service routine to support a clock-based annunciator system. One of the essential functions of an automated annunciator system is timekeeping. At each timekeeping interrupt 200, the timekeeping service routine 202 acquires a date-time message 204 from a clock 206 that may preferably feature high precision, and parses the date-time message 206, extracting time of day and calendar fields.

The timekeeping service routine 202 then checks for coincidence 216 against a list of scheduled transmissions 218. If a scheduled event is enabled 222 per an enablement list 220, then a command string can be generated 224 and transmission 226 can occur. If transmission is not scheduled 216 or is not enabled 222, then hibernation 230 occurs at that time. If, after a transmission, no response is required from the annunciators to which the transmission is directed, as for example if a specific tone of fixed duration is scheduled, then the task ends as soon as the transmission 226 is complete, and the system can confirm that no response is needed 228 and hibernate 230 until the next time interrupt 200; otherwise, control passes to another routine to get a reply 232.

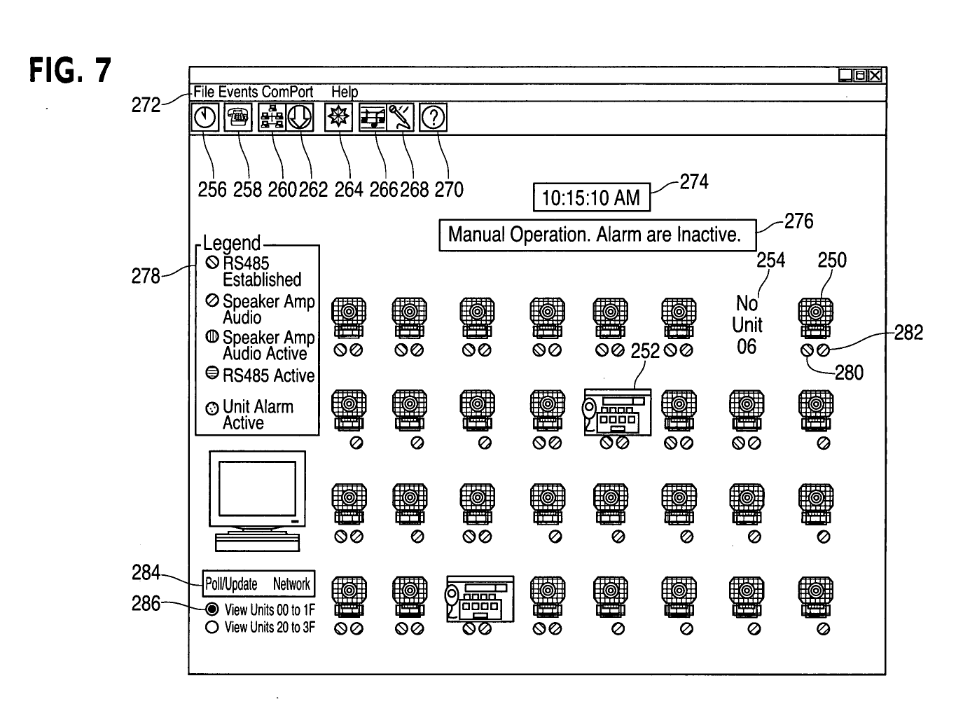

FIG. 7 illustrates a representative user interface display, in which icons representing annunciators 250 and remote panels 252 provide immediate confirmation of the existence of individual units. An uninstalled unit address 254 is so listed in memory, is confirmed when polled, and is so displayed. Buttons allow keyboard or point-and-click access to functions such as Timed Event Creation/Editing 256, communication Corn Port configuration 258, network polling/updating 260, quick removal of noncommunicating units and remapping of the entire network 262, controlling entry and exit to the Monitor mode 264, tone selection 266, access to prerecorded voice segments 268, and access to help screens 270. Pull-down menus 272 are shown for subjects File, Events, ComPort, and a repeat of Help; these can be repeats in text form of individual functions that have button access, and can offer additional functions less often needed, as is common in GUI-based systems.

FIG. 7 further illustrates that clock time 274 can be displayed continuously, along with a text summary of system status 276. The Legend block 278 provides a reminder of the interpretations of colors, here illustrated by hatching patterns, associated with status information. As indicated, this permits high density of status summary, rapid familiarization, and rapid detection of discrepancies.

Beneath each icon, two dots, color-coded as shown in the Legend 278, are shown as representative indicators for the type and status of individual annunciators. The presence of the leftmost dot 280 in this embodiment indicates that the unit is either a speaker amplifier 250 or a system panel 252, either of which can amplify sounds sent to it on the analog audio line. Absence of the leftmost dot 280 indicates that the unit is a tone generator, responding to commands to generate tones but not able to radiate analog signals. The rightmost dot 282 indicates IEC-485 status. The two dots 280 and 282 can change color in accordance with the Legend 278 depending on their status. For example, if IEC-485 communication with a specific annunciator has been established without error but is currently not active, that annunciator's right hand dot 282 will be yellow. During activity such as polling, the same dot 282 will change to green, indicating the activity, and then revert to yellow when the communication is over. Absence of the right hand dot 282 indicates that IEC-485 communication is in error or cannot be established.

In the embodiment shown, clicking on an annunciator serves to inquire as to its zone number, which is displayed in a window.

The display may use unique icons to distinguish between physically similar speaker amplifiers and tone generators to reduce the need for indication of type by dots as shown in FIG. 7. Annunciators may be capable of both tone generation and analog amplification functions. Using multiple dots can eliminate need for color discrimination. The zone number can be displayed continuously instead of in response to an inquiry.

The Poll/Update Network soft button 284 allows substantially immediate, asynchronous polling of the status of all addresses. Soft buttons 286 can further permit selection between groups for systems which have more annunciators than readily fit on a screen. Reduction in icon size can permit more icons to be displayed at one time, and switching between low-and high-resolution icons—which zooms in to get more detail in a part of the display—can permit further increase in information density without making the display unreadable.

The arrangement in FIG. 7 shows the icons on a grid. In an alternative format, the user can position the icons to correspond to their physical locations, such as by floor in a multistory office building, aligned on an elongated factory floor, and other arrangements that can assist the user in visualizing system status.

An annunciator system according to the embodiments described herein can improve on previous annunciator systems. Existing-system central control processors are in many instances entirely manual, so that while they may support individual-annunciator, zone, and all-call addressing as well as auxiliary analog transmission, such central control processors may in practice reach an operability limit as the number of annunciators becomes large. Manual-only central control processors are in many instances virtually entirely lacking in the record keeping, dynamic configuration control, and user training and support functions that are intrinsic capabilities of systems using graphics-oriented central control processors.

Alternate central control processor hardware in some embodiments of the invention may take different physical form, such as placement of the equivalent of an off-the-shelf personal computer in a panel mounted configuration, and can feature a variety of user interface styles, such as a free-standing or embedded display; touch screen interface in lieu of or in addition to a mouse, trackball, stylus, joystick, touchpad, or other positioning device; and/or a keyboard that is free-standing, fold-down, or flush in the panel. Audio output for a user at the central control processor location can be implemented with speakers or headphone jacks.

Sound inputs can take a variety of forms as well. A sound card plugged into an off-the-shelf personal computer or the equivalent function embedded in the motherboard of such a computer can provide a sound output level controllable by the user through the features of the GUI or through functions in application software. The high-level sound signal needed to send analog sound to whichever annunciators and subordinate panels can accept analog sound as an input can be provided by an off-the shelf, stand-alone amplifier or as part of a combined IEC-485 and audio transmitter. Either such device can be installed in a panel-mount package, as a combination of desktop devices, or in another packaged system.

The IEC-485 transceiver function for the central control processor is described in the first instance as a commercial IEC-232 to IEC-485 converter. This is one of several practical implementations, others of which include a dedicated circuit board within a personal computer and converters accepting non-IEC-485 inputs, such as USB. While IEC-485 is used in the embodiment shown, other communications standards can be employed.

A second major change from established practice concerns addition of time data to annunciator systems. Whereas standard annunciator control panels are generally limited to being activated by sequences of manual button pushes, the embodiment shown can schedule annunciator events an indefinite time into the future, can schedule events according to sequences whose complexity is excessive for performance by manual methods, can be set to occur once or to repeat daily, weekly, annually, or at any other interval, and can reconfigure dynamically, either for normal use or as a casualty response—for example, a particular annunciator can be assigned to one zone during the week and another on weekends, or a workspace within a zone can have music during second shift only; for a contrasting example, a system can be set up to change tones or reallocate annunciators between zones if other annunciators develop failure indications. The addition of time control allows reliable operation of large and complexly configured systems without need for active supervision by an operator. Detection and localization of at least some classes of failures can be speeded up. System setup and user training can each be performed offline, avoiding workplace distractions such as unexpected bells sounding during the workday.

The above description of a hardware system with extensive software content can be enhanced by additional hardware and software in accordance with the continuation presented herein. Core hardware as described acquires the enhancement of more capable interface to external resources, while software is extended to fully exercise the added resources and the extended interface functions required.

The satellite hardware described above is substantially oriented to the generation of output signals, meaning that each of the units connected to the central control device is intended to perform annunciation in one or another form—sound (tones, bells, recorded or synthetic speech, or the like), light, vibration, and the like. The above satellite hardware can reply to inquiries by the central control device, but primarily supports diagnosis of the operating condition of the satellite hardware itself. Typical events may take place in embodiments of the above system at specific times or after elapsed time intervals, in response to stimuli from a timekeeping apparatus within the annunciator system. Thus, the occurrence of asynchronous or untimed events in a system according to the above description is largely limited to actuation by a user at the master control console after establishing manual control.

The present invention couples the annunciation function described above with the monitoring and management of external, non-annunciatory apparatus. Hardware elements that implement this extended functionality include input-oriented interface subsystems that can detect and manage electronic signals from non-annunciator devices and output-oriented interface subsystems that can perform activities such as dialing telephones and actuating external equipment such as fans and lights. Software elements that implement this extended functionality include control routines to operate interface subsystems, timekeeping functions to provide support to devices with a variety of latency times, management functions to capture event information, invoke support activities, prioritize responses, and perform escalation and deescalation between event-response and routine operation, and display functions to refresh the user interface.

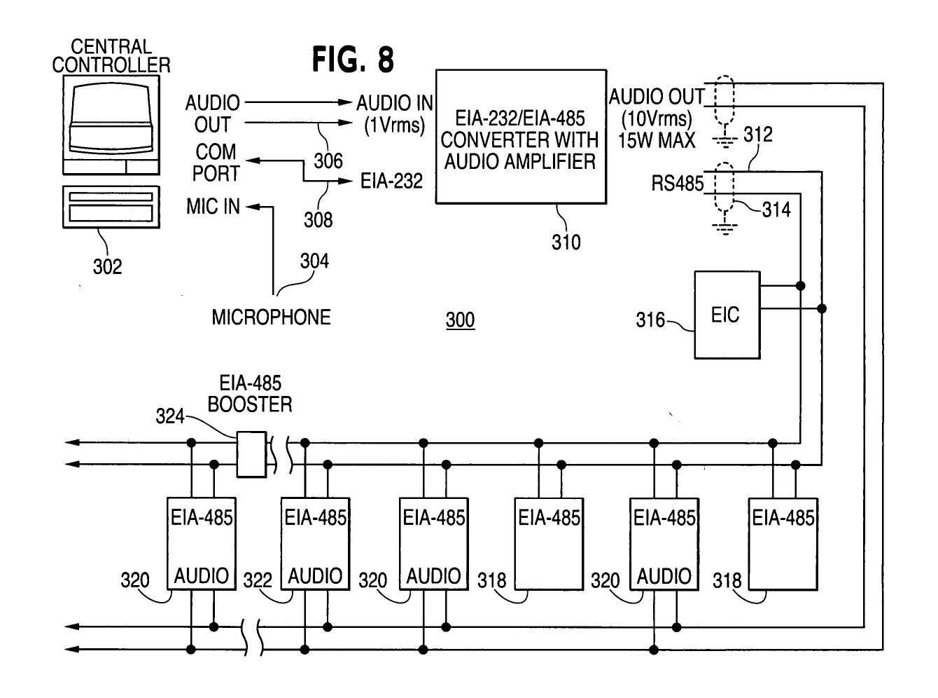

FIG. 8 is a connection diagram showing representative hardware components of a system 300 incorporating the present invention. A Master or Central Controller 302 can be of any of a variety of physical configurations, including a conventional desktop personal computer (PC), a rack-mounted commercial equivalent device, a laptop, and a dedicated wall-mounted electrical panel. The system 300 preferably includes in its Central Controller 302 a microprocessor with a sufficiency of hardware resources. Desirable hardware resources in most embodiments likely include at least random-access memory, data and software storage using flash memory, a hard drive, or the like, interface input/output functions such as a display, a keyboard, a pointing device, speakers, and a microphone 304, and remote-oriented functions such as an audio signal “line” output 306, bidirectional communication ports such as an IEC-232 “COM” port 308, and an Ethernet® port.

The audio line output 306 and the COM port 308 in FIG. 8 are shown connected to an external bidirectional IEC-232 to IEC-485 converter with audio amplifier 310. As discussed above, IEC-232 can be used directly, that is, a single-ended signal may in some embodiments be used alone, but it is likely for most embodiments that a multi-mastering, short-circuit-resistant bus 312 such as the differential IEC-485 is desirable. The bus converter 310 shown is an external device, which allows the bus to connect to a non-differential, non-bused, single-master IEC-232 port 308 of the type commonly provided with PCs. In other embodiments, IEC-485 bus interface may be realized using an internal converter, which can be fitted to an expansion bus slot within the Central Controller 302, or a converter that is an integral part of a Central Controller 302 circuit board. The audio line 306 is shown served by an external, higher output driver built into the external IEC-485 converter 310. It is desirable that the audio driver be differential, or at least isolated, unlike some PC line out ports. A line amplifier in an expansion bus slot or integral with the Central Controller 302 circuit board may be preferred in some embodiments. The use of isolation can reduce the likelihood of wiring failures causing cascaded hardware failures, while differential lines can be capable of continued operation after a single failure. The shield 314 shown can reduce coupling of noise in and out of the buses; a ground reference is preferred in many IEC-485 applications.

The External Input Capable units 316 will be discussed in more detail subsequently. The other devices shown are substantially the same as those described previously, namely digitally driven tone generators 318, digitally driven speaker/amplifiers with analog amplifiers and digital function control 320, system panels 322 operated in satellite mode, and IEC-485 repeaters 324. Each of these devices is assigned an address on the IEC-485 bus. A representative embodiment of IEC-485 for annunciators uses 5-bit addresses and is thus limited to direct addressing of 32 devices, where the converter 310 and the repeater 324 may each have an address, as do each of the audio devices 318, 320, and 322. Other embodiments may use longer address blocks, which message structure can permit an increased number of directly-addressed devices, traded off against decreasing the load drawn by each receiving device in order to accommodate the limited total output current for IEC-485, or else varying from the IEC-485 specification. Other bus architectures may be capable of driving more loads or operating at higher data rates, and may thus be preferred to IEC-485 for some embodiments.

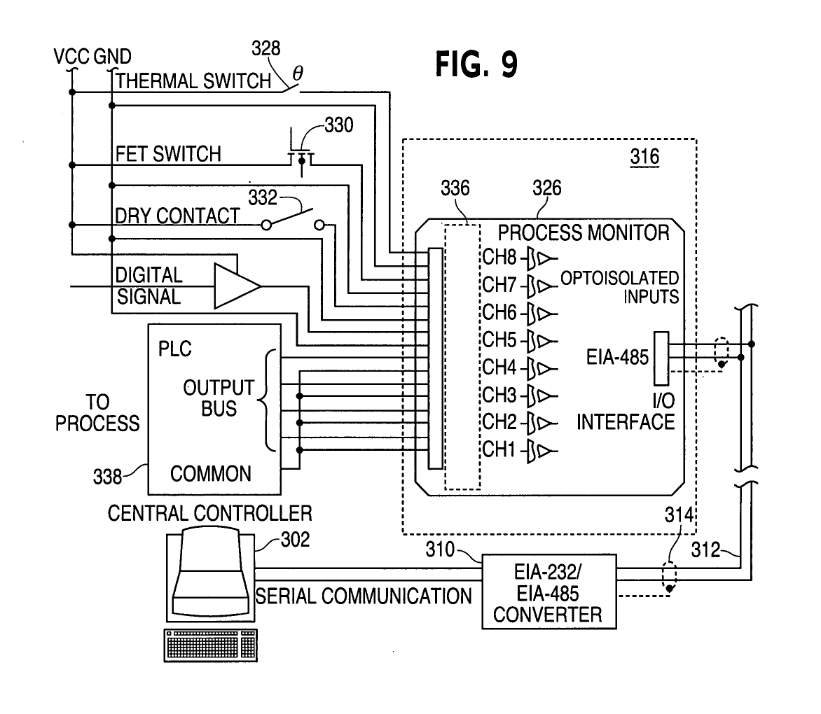

FIG. 9 is a block diagram showing an External Input Capable (EIC) unit 316 and its associated connectivity. An annunciator system in accordance with the present invention can support at least one EIC unit 316. EIC units 316 may have a variety of physical dimensions, and may be ruggedized, waterproof, or otherwise enhanced for hostile environments. Each EIC unit 316 has at least one interface circuit board 326 or a functional subassembly embedded within another circuit board in the EIC unit 316 that is capable of connecting to external electronic devices. The EIC circuit board 326 shown includes eight pairs of input lines. The number of lines provided on a typical commercial EIC circuit board developed in accordance with the present invention may vary as determined by market demand, desired circuit board size, word length allowances in other components of existing products, and other factors.

A variety of representative EIC inputs 328, 330, 332, and 334 are shown in FIG. 9. For broad compatibility with existing external hardware, EIC inputs 326 may be capable of sensing switch closures, digital data signals, or a variety of analog signals. Each of the EIC inputs 328, 330, 332, and 334 in the embodiment shown can be fitted with optical isolation, in order that an applied external signal with significant DC voltage offset, AC ripple, or other nonsignal electrical content will not damage the EIC unit 316 and will not have an appreciable effect on other inputs. Fiber optic signal input may be preferred in some embodiments, which can provide such specific benefits as compatibility with specific source devices, intrinsic high voltage isolation, substantial freedom from coupling of source defects such as ripple and electrostatic discharge, and low susceptibility to radiated or induced electromagnetic interference.

FIG. 9 shows, as examples, a thermally actuated mechanical switch 328, an electronic switch 330, and a so-called dry contact switch 332. Each of these switch types requires at least a minimal current flow in order to transfer a signal. Typical non-dry-contact mechanical switches 328 commonly have similar-metal contacts (coin silver, copper, palladium, etc.) welded to conductive actuator fingers (spring brass, etc.) so that a motion, such as the flexing of a bimetallic strip for a thermal switch or a pressure diaphragm for a pressure switch, the motion of a machine part for a limit switch, or the arrival or removal of a magnet for a reed switch, can permit an electrical circuit to be established or interrupted.

An electronic switch 330 such as a field effect transistor (FET) switch changes conductivity under control of an electronic signal. Used as a switching device, a turned-on FET switch can, for example, cause an input to the EIC unit 316 to be pulled low or high, whereas that input is normally drawn to a common voltage or ground reference by a resistor connected from the input to the reference.

Dry contact switches 332 are mechanical switches that differ from more conventional types largely in requiring that the open-circuit voltage, closed-circuit current, and effective circuit capacitance be relatively low to allow the circuit to actuate and deactuate with minimal arcing, whereas non-dry-contact switches generally require application of significant current flow to burn through any oxides formed by arcing and exposure to air. Additional switch types include mercury-wetted switches, the contacts of which are self renewing; Hall effect switches, in which a current path through a bulk semiconductive material is distorted by the presence or absence of a magnet; switches in which resistance varies with pressure and a threshold is used to determine when contact has been made; capacitive and inductive switches, in which circuit properties such as the frequency of an oscillator change with the motion of components or the presence of an object near a sensitive zone; and many other switching technologies.

It can be desirable that an input port to an EIC circuit board 326 be capable of sensing signals from many switch and data acquisition device (transducer) types without requiring additional apparatus, but it is to be understood that some transducer technologies are intended to be used with particular support hardware that commonly requires input power and that provides signal output rather than, for example, switch closure output. Thus, an input port to an EIC circuit board 326 may preferably be capable not only of providing power and/or ground in support of a relatively wide range of switch technologies, but may also be capable of detecting signal inputs over a relatively broad range without damage, and, according to user preference, of providing power for some active devices.

The optoisolator function identified in FIG. 9 can provide significant voltage separation—in some embodiments, on the order of kilovolts—and can be designed to permit an input signal to have an extremely wide range of amplitude without damaging the optoisolator input section. For example, an infrared emitting light emitting diode (LED) used as the input section of an optoisolator can be protected with circuit protection devices so that excessive voltage at an input port to an EIC circuit board 326 cannot appear across the LED. If a two-terminal connection is provided for each input to an EIC circuit board 326, then internal jumpering or an uncommitted “scratch area” 336 within the EIC circuit board 326 can provide power, a series or shunt resistor, a capacitor-resistor network, back-to-back rectifiers, a zener diode, a ground reference, or another form of circuit completion, as appropriate for each of a variety of circuits.

FIG. 9 also shows input to the EIC circuit board 326 in the form of a programmable logic controller (PLC) 338, which is an industry term that generally refers to a microprocessor, digital signal processor (DSP), or the like embedded in or controlling a piece of apparatus that performs a specialized process. A typical task for a PLC 338 might be operation of a machine tool, a conveyor belt, or a battery charger, for example. The generic PLC 338 is shown to provide a four-bit bus signal 334 to report any of a number of possible conditions within the PLC 338. It is to be understood that the data rate at the bus 334 is preferably compatible with the rate at which the EIC circuit board 326 can capture and transfer the data from the PLC 338. As indicated in FIG. 9, a single-ended bus, referencing the ground level within the PLC 338, can be detected by some embodiments of the EIC circuit board 326. The inputs of the EIC circuit board 326 may be adaptable in some embodiments to accept differential signals of appropriate amplitude and offset.

The interface between the EIC circuit board 326 embodiment shown in FIG. 9 and the remainder of the annunciator system 300 of FIG. 8 is a single IEC-485 bus differential pair 312 with a shield 314. Not shown separately in FIG. 9 is a ground reference signal that may be the shield 314 or a separate line. When the board 326 detects that it has received an inquiry that includes the address of the board 326, the board 326 can respond by transmitting a reply containing the board 326's address and the state of all of the input signals connected to the board 326, as well as such reply message components as a command echo, start and end signals, and a checksum, if used. The embodiment shown in FIG. 9 includes the bidirectional IEC-232 to IEC-485 converter 310 from FIG. 8. The converter 310 accepts reply messages from the board 326, as well as from any other EIC and non-EIC units connected to the bus 312, and converts them to IEC-232 for input to the Central Controller 302.

Also not shown in FIG. 9 is a full-duplex configuration described in the standards document for IEC-485 that permits the outgoing and return signals to be assigned separate pairs, and a separate clock pair that allows synchronous operation. Full-duplex configuration and synchronous operation may be preferred in some embodiments, since these features ease some timing requirements. Multiple mastering, inconsequential in many annunciator embodiments, is realizable in either configuration. Since the half-duplex configuration can require less hardware and fewer connections, that is the configuration described in greater detail herein.

Any of several embodiments of EIC-compatible annunciator hardware may be preferred. The embodiment shown in FIG. 9 suggests a substantially stand-alone EIC unit in which an external power source and one EIC circuit board 326 in a protective housing may constitute the complete embodiment. In another embodiment, the functions of the EIC circuit board 326 may be embedded within an external device, such as a PLC 338. In still another embodiment, an EIC circuit board 326 or its functions may be installed within one of the other annunciation system devices in FIG. 8, such as a tone generator 318, a speaker/amplifier 320, or a system panel 322. In some embodiments, the EIC unit 316 may not have a separate address, but may share an address with another function.

In some embodiments, an EIC unit 316 may acquire one or more analog signals. Analog input may be acquired from an external analog-to-digital (A/D) converter that uses multiple digital data bits on separate data lines, a method substantially suited to the EIC circuit board 326 described above. Other EIC units may include analog voltage comparators, which may be external or internal to an EIC circuit board. A representative use for an analog voltage comparator is to provide a single bit go/no go or voltage threshold indication regarding one analog input. Still other EIC units may include A/D converters internal to EIC circuit boards, or may include other suitable input techniques, such as strain gauge, encoder, or synchro signal reception, which may require different EIC circuit board designs.

All EIC units 316 described thus far accept signals related to external events as inputs. Other EIC units 316 may have one or more outputs, either in addition to or in place of inputs. Outputs can be assigned many functions, such as, for example, handshaking for external data ports. Such a port handshaking signal could, for example, supply a strobe pulse for the data bus from the PLC 338 in FIG. 9. Still other EIC units 316 could provide control signals to external devices. For example, a school or warehouse equipped with multiple motion detectors might enable alarms associated with some of its detectors only after normal operating hours, rather than sensing and discarding extraneous alarms during the day. Control signals from EIC units 316 could be used, for example, to turn each detector on and off, as well as to initiate test functions or to perform other tasks. Likewise, a sensed after-hours motion detection event could be a stimulus for which the response could be to dial a telephone number using a modem installed in the Central Controller 302, wait for an answer, and output a prerecorded message, in addition to or in lieu of sounding an audible alarm within the annunciator system at the site.

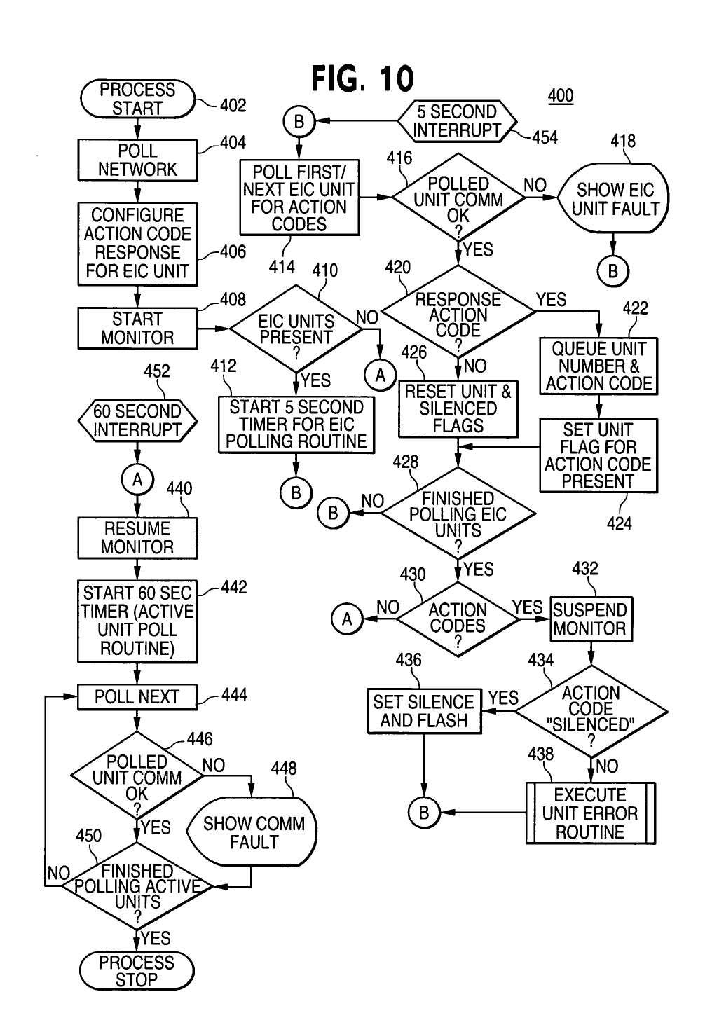

The novel EIC hardware described above requires extension to existing annunciator software in order to use the added functionality. FIG. 10 is a flowchart that summarizes a normal initialization and operation routine for a software-driven annunciator system that includes EIC hardware. The capability introduced with EIC is associated herein with the term ACTION Codes, which summarize the distinguishing properties of EIC units 316.

It is to be understood that, while a typical hardware Central Controller 302 embodiment for use with the present invention may be a substantially conventional Personal Computer, and while a typical Personal Computer incorporates a microprocessor that generally performs the execution of software in the form of stored programs to acquire, manage, and output information, nonetheless alternative types of apparatus can accomplish substantially the same end results, namely information acquisition, management, and output, without using stored programs as such. The activity that allows either such an alternative apparatus or a conventional Personal Computer to achieve these end results may be characterized as an autonomously executable process sequence. Execution by a microprocessor of a program stored in memory is an example of an autonomously executable process sequence.

FIG. 10 begins the routine 400 with a start function 402 that assumes that any initialization functions have been performed, such as initialization of a Microsoft® Windows® graphical user interface (GUI) in a PC-based Central Controller that uses Windows®. An initial polling 404 of the IEC-485 bus-connected network can poll every possible address, receiving responses from all installed and functioning (ACTIVE) devices and timing out for unused addresses. The responses will include data bits that distinguish between EIC units 316 and conventional units. The installed EIC devices and their properties can be indicated graphically by the software using the method described above, with an additional graphical identifier such as an extra dot or a unique icon indicating that an ACTION Code has been returned for the EIC units 316 when polled.

Configuration 406 can be performed on each EIC unit 316 as needed by selecting the unit, using arrow keys, mouse motion, keying an identifier into a window, selecting an identifier from a pulldown list, or another method as appropriate, then indicating by another function such as a mouse right click that configuration is to be performed. In a preferred embodiment, this can cause a setup window to be opened, although alternative access methods may be preferred in some embodiments, such as editing a text file with a properties list for a specific EIC unit 316. Configuration 406 includes specifying the activities that are to take place for each state of each bit to be input for each EIC unit 316. Thus, if bit 7, for example, is normally a zero, then nothing is to be done as long as it remains a zero. If the event of bit 7 becoming a 1 represents an out-of-range indication on a temperature sensor, for example, then the setup 406 for that ACTION Code may include identifying a specific prerecorded voice announcement and identifying selected zones in a building in which the announcement is to be played as well as the repetition frequency, details concerning logging of the event, and the like. The configuration 406 procedure is performed for each EIC unit 316 in the system.

Once all EIC units 316 are configured, it is possible to enter MONITOR mode (normal operation) 408, which begins by reviewing 410 a stored list to find any EIC units, initializing the 5 second timer 412, and polling 414 all of the EIC units after every 5 seconds timer tick. Each EIC unit is evaluated for responsiveness 416 (if nonresponding, this failure is displayed 418 and the loop continued with the next EIC unit) after which the poll message is parsed 420 for and ACTION Code. If there is an ACTION Code, the EIC unit address and the code are entered in a queue 422 and a Unit flag is set 424. If there is no ACTION Code, either because there has been no code or because a previous condition has been resolved, then a set Unit flag and a set SILENCED flag are reset 426. If some EIC units are yet unpolled for this loop 428, then the software jumps to poll the next EIC unit 414.

If all EIC units are polled, then the presence of Unit flags is checked 430 to determine if pending ACTION Codes exist. If there are no Unit flags set, the software jumps back to normal mode 408. Otherwise, MONITOR mode is marked as suspended 432, which inhibits initiation of timed events. If the ACTION Code item is SILENCED 434, then the display icon for that item should be set to flash 436 and the next EIC unit polled (jump to 414). If the ACTION Code item is not SILENCED 434, then the set of specific functions called for in the setup 406 for the current EIC unit are executed 438 and the next EIC unit polled (jump to 414).

In the case where polling of all EIC units during a 5 second interval is complete 428, then suspension of the MONITOR function is canceled 440 and the 60 second timer is started 442, which is a repeat of the ACTIVE unit polling routine described above for non-EIC systems. This routine polls an ACTIVE unit 444, decides whether that unit is operational 446, displays the failure if the unit is not responding 448, and continues until all ACTIVE units have been polled 450. Once the ACTIVE list has been polled, the process is ended until the 60 second interrupt restarts it 452. Normally, this will be overridden by the 5 second interrupt, which will cause the routine to jump to 454.

Each EIC unit 316 has at least one attribute distinguishing it from non-EIC units, principally that the EIC unit 316 has an interface with apparatus outside the annunciator system. In support of this, each such unit, when polled, responds with a reply message including at least one flag bit unique to EIC units.

It is assumed for purposes of this specification that all EIC units 316 are adequately served if they are polled every 5 seconds, and that all non-EIC units are adequately served if polled every 60 seconds. For embodiments in which such performance characteristics are inappropriate, such as where EIC units 316 need to be polled more often, or where long wires necessitate a low data rate, so that polling must occur less often, timing may be adjusted so that all units are adequately served. It is to be understood that the polling function applies to digitally connected devices only, and that audio-only devices, referred to herein as “dumb” amplifiers, may also be installed in a system, connected to one of the audio output buses, and, in a typical system, powered locally from premises electrical power. It is further to be understood that outgoing transmissions from a master controller may occur at any time, may occur in addition to the polling functions described herein, and may include reconfiguration commands, such as zone and tone number assignments and other outgoing commands to individual devices on the bus.

The annunciator systems described herein rely on polling from a single master controller functioning as a timekeeper. In an alternative embodiment, timekeeping signals can be broadcast from a central unit to multiple masters, each of which in turn polls its own satellites. The return signals from such multiple masters may be passed back to the central unit for consolidation. Annunciation processes such as generating tones, playing prerecorded voice announcements, and the like may be local to each master or centrally controlled as required in an application.

Another alternative embodiment may preferably establish timing independently at each satellite, so that each satellite transmits in response to an internally generated scheduling signal instead of or in addition to an external polling signal. Independent timing resources in satellites may be synchronized, in which case they may receive broadcast time signals from a master controller or from a resource such as a time broadcast service. Unsynchronized satellite controllers may employ a communication protocol that supports priority-based transmission, such as Controller Area Network (CAN bus, International Organization for Standardization (ISO) 11898), in which multiple asynchronous, priority-weighted talkers use arbitration to acquire the bus, or collision avoiding transmission, such as some versions of Ethernet®, for transmitting asynchronously. Satellite transmissions in some embodiments may occur in response to asynchronous external input events.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to that fall within the scope of the invention.

1. A programmable annunciator system, comprising:
a master controller;
a satellite controller distal to said master controller, wherein said satellite controller is linked to a device external to the programmable annunciator system, said satellite controller comprising an interface device configured to receive an information element concerning the external device;
a communications medium that links said master controller and said satellite controller; and
a message protocol configured to support signal interchange between said master controller and said satellite controller.

2. The programmable annunciator system of claim 1, wherein said satellite controller is configured to cause the emission of at least one signal by at least one annunciator device when so commanded by said master controller.

3. The programmable annunciator system of claim 1, wherein said interface device is configured to incorporate said information element into said at least one message.

4. The programmable annunciator system of claim 1, wherein said interface device further comprises at least one of a non-zero voltage reference for an external electrical switch and a ground reference for an external electrical switch.

5. The programmable annunciator system of claim 1, wherein said interface device further comprises an electrically isolated input port, wherein said input port is an electronic circuit capable of distinguishing between two logic states in an electrical signal applied to said input port, and wherein said electrical signal is characterized in part by an offset voltage.

6. The programmable annunciator system of claim 1, wherein said interface device further comprises a data input port with a plurality of signal lines.

7. The programmable annunciator system of claim 1, wherein said interface device further comprises an output signal generator configured to providing a data acknowledgement output signal to a device external to the programmable annunciator.

8. The programmable annunciator system of claim 1, wherein said interface device further comprises at least one from the group consisting essentially of:
an input configured to operate as an analog comparator;
an input configured to operate as an analog to digital converter;
an input configured to operate as a fiber optic receiver;
an output configured to operate as a digital to analog converter; and
an output configured to operate as a fiber optic transmitter.

9. The programmable annunciator system of claim 1, wherein said communications medium further comprises:
a master communications port, wherein said master communications port provides bidirectional signal traffic to said master controller;
a satellite communications port, wherein said satellite communications port provides bidirectional signal traffic to said satellite controller; and
a linkage mechanism whereby message content transmitted from said master communications port is received by said satellite communications port in an accessible form, and whereby message content transmitted from said satellite communications port is received by said master communications port in an accessible form.

10. The programmable annunciator system of claim 1, wherein said annunciator system master controller further comprises at least one from the group consisting essentially of:
a computer-readable clock to furnish timekeeping information to said annunciator system master controller;
an interface subsystem that supports command and configuration input and display for said annunciator system master controller;
a nonvolatile storage subsystem that supports storage and retrieval of data on behalf of said annunciator system master controller;
an external communication provision that comprises a telephone modem; and
an external communication provision that comprises an Ethernet® port.

11. The programmable annunciator system of claim 10, wherein said interface subsystem further comprises at least one from the group consisting essentially of:
a video display device, whereupon images related to command and configuration input and display are presented;
a keyboard-type data entry device wherewith data and commands comprising keystrokes are entered into said system;
a touch screen-type data entry device, wherewith at least one of position, selection, and activation inputs are entered into said system;
a positioning data entry device, wherewith position data and activation command data are entered into said system;
a microphone-type audio input device, whereby sounds are converted to an audio electronic signal for further processing within said interface subsystem;
a first sound signal processing device, whereby said audio electronic signal from said microphone-type audio input device is converted into a form in which said audio electronic signal can be processed by said annunciator system master controller;
an audio output signal driver; and
a second sound signal processing device, whereby an audio output is converted from a form in which said audio output can be generated by said annunciator system master controller into a form in which said audio output can be amplified by said audio output signal driver.

12. The programmable annunciator system of claim 10, wherein said nonvolatile storage subsystem further comprises at least one from the group consisting essentially of:
a disk drive, disk drive interface electronics, and disk drive operating software;
nonvolatile, solid-state read-write memory (NVRAM) and interface electronics; and
an external electronic data storage device.

13. The programmable annunciator system of claim 1, further comprising:
an autonomously executable process sequence to implement functions of the annunciator system.

14. The programmable annunciator system of claim 13, wherein said process sequence further comprises:
a survey inquiry routine configured to transmit an inquiry to an address associated with the satellite controller, thereafter to await one of a response from said satellite controller and a timeout;
a survey storage routine, wherein a characterization for said satellite controller is entered into a configuration list; and
an initialization routine to configure said process sequence to employ external data acquired by at least one satellite controller external input capable interface device.

15. The programmable annunciator system of claim 14, wherein said timeout further comprises the passing of a time interval exceeding a specified maximum time for a specified number of inquiry repetitions

16. The programmable annunciator system of claim 14, wherein said characterization comprises one from the group consisting essentially of having no controller, having an active, external input capable controller, and having an active, non-external input capable controller.

17. The programmable annunciator system of claim 14, wherein said process sequence further comprises:
a polling routine to acquire data from a satellite controller with an address;
a first sequencing routine to identify an address of a next external input capable satellite controller to be polled and to trigger said polling routine with said address;
a second sequencing routine to identify an address of a next non-external input capable satellite controller to be polled and to trigger said polling routine with said address;
a timing routine for external data, whereby a first triggering signal to begin execution of said first sequencing routine for external input capable satellite controllers is provided; and
a timing routine for internal data, whereby a second triggering signal to begin execution of said second sequencing routine for non-external input capable satellite controllers is provided.

18. The programmable annunciator system of claim 14, wherein said process sequence further comprises:
an annunciation routine, whereby internally generated and externally generated data are subjected to analysis and, where indicated by the results of said analysis, cause at least one annunciation signal to be transmitted to at least one satellite controller.

19. The programmable annunciator system of claim 13, further comprising a reporting process wherein an external input capable satellite controller transmits information to a master controller, wherein an attempt to transmit occurs at a time determined by a stimulus from the group consisting essentially of a real time clock based schedule, a schedule not based on a real time clock, an occurrence of a state change in a signal from an external input to the satellite controller, expiration of a random time delay interval, expiration of a delay following a transmission collision, and arbitration.

20. A programmable annunciator system, comprising:
means for generating a polling message in a master controller, wherein the polling message comprises an address for a satellite controller;
means for transmitting the polling message from the master controller; and
means for conveying the polling message from the master controller to at least one satellite controller, wherein the at least one satellite controller is configured to acquire an information element from an external source.

21. The programmable annunciator system of claim 20, wherein the polling message further comprises a request for a reply from the satellite controller, wherein the reply is to include at least one information element from at least one external source.

22. The programmable annunciator system of claim 20, wherein the means for conveying the polling message further comprises a bidirectional, differential, bused communication system.

23. The programmable annunciator system of claim 20, further comprising:
means for receiving the polling message at the satellite controller.
means for analyzing the polling message at the satellite controller;
means for generating a reply at the satellite controller, wherein the reply comprises a plurality of information elements, and wherein the information elements comprise:
an address echo for the satellite controller;
a signal indicating whether the satellite controller is external-input capable; and
a status signal for the satellite controller;
means for transmitting the reply by the satellite controller; and
means for conveying the reply from the satellite controller to the master controller.

24. The programmable annunciator system of claim 23, wherein the plurality of information elements of the reply further comprises at least one external-input data element supplied from at least one external source.

25. The programmable annunciator system of claim 24, further comprising:
means for receiving the reply at the master controller;
means for analyzing the reply at the master controller; and
means for integrating at least one of the plurality of information elements of the reply into a system data structure by the master controller.

26. The programmable annunciator system of claim 25, further comprising:
means for periodically polling to request data from the at least one satellite controller, with a polling periodicity rate controlled by the master controller;
means for storing the periodically requested data, wherein the periodically requested data includes the address and status of the at least one satellite controller and the external-input data acquired by the at least one satellite controller;
means for displaying the stored data; and
means for revising the stored data.

27. The programmable annunciator system of claim 26, wherein the means for displaying the stored data further comprises means for distinguishing between satellite controllers that can acquire external-input data and satellite controllers that cannot acquire external-input data using a distinguishing display feature.

28. A method for annunciating in a system that accepts external inputs, comprising the steps of:
transmitting a polling message from a master controller, wherein the polling message comprises an address for a satellite controller, and wherein the polling message further comprises a request for a reply from the satellite controller;
receiving the polling message at the satellite controller;
analyzing the polling message at the satellite controller;
generating a reply at the satellite controller, wherein the reply comprises a plurality of information elements, and wherein the information elements comprise:
an address echo for the satellite controller;
a signal indicating whether the satellite controller is external-input capable; and
a status signal for the satellite controller; and
transmitting the reply by the satellite controller to the master controller.

29. The method of claim 28, wherein the plurality of information elements of the reply further comprises at least one external-input data element supplied from at least one external source.

30. The method of claim 29, further comprising:
receiving the reply at the master controller;
analyzing the reply at the master controller; and
integrating at least one of the plurality of information elements of the reply into a system data structure by the master controller.

31. The method of claim 30, further comprising:
periodically polling to request data from the at least one satellite controller, with a polling periodicity rate controlled by the master controller;
storing the periodically requested data, wherein the periodically requested data includes the address and status of the at least one satellite controller and the external-input data acquired by the at least one satellite controller;
displaying the stored data; and
revising the stored data.

32. The method of claim 31, wherein displaying the stored data further comprises distinguishing between satellite controllers that can acquire external-input data and satellite controllers that cannot acquire external-input data using a distinguishing display feature.
